(19) United States
(12) Patent Application Publication
(10) Pub. No.: US 2011/0288904 A1
(43) Pub. Date: Nov. 24, 2011

(54) System, Method, and Software for Analyzing Maneuvers of an Application in a Distributed Computing Environment

(75) Inventors: Suzanne P. Hassell, Clearwater, FL (US); James D. Janscha, Mesquite, TX (US); Jeffrey J. Wiley, Rockwall, TX (US); Paul F. Beraud, III, Parrish, FL (US); Alen Cruz, Tampa, FL (US); Armando J. Santos, St. Petersburg, FL (US); Juan E. Sandoval, St. Petersburg, FL (US); Nicholas I. Sapankevych, Clearwater, FL (US); Frederick E. Bass, JR., Sarasota, FL (US)

(73) Assignee: Raytheon Company, Waltham, MA (US)

(21) Appl. No.: 12/914,207

(22) Filed: Oct. 28, 2010

Related U.S. Application Data
(60) Provisional application No. 61/347,286, filed on May 21, 2010.

(51) Int. Cl. G06Q 10/00; G06N 5/02

(52) U.S. Cl. 705/7.25; 706/46

(57) ABSTRACT

In certain embodiments, an application maneuvering analysis tool accesses application characteristics information indicating one or more characteristics of an application for which a maneuver evaluation is desired. Using the accessed application characteristics information, the application maneuvering analysis tool determines a maneuverability index representing a maneuvering efficiency of the application and determines an implementation difficulty level according to the determined maneuverability index.

### RELATED APPLICATIONS

This application claims the benefit under 35 U.S.C. §119(e) of the priority of U.S. Provisional Patent Application Ser. No. 61/347,286, entitled “System, Method, and Software for Analyzing Maneuvers of an Application in a Distributed Computing Environment,” filed May 21, 2010, the entire disclosure of which is hereby incorporated by reference.

### TECHNICAL FIELD OF THE DISCLOSURE

This disclosure generally relates to computing systems, and more particularly, to a system, method, and software for analyzing maneuvers of an application in a distributed computing environment.

### BACKGROUND

Distributed computing systems distribute processing load to a number of constituent computing platforms that communicate with one another through a network. Distributed computing systems have certain advantages over their centralized counterparts. For example, they may provide parallel processing techniques to ease computational burden, and unlike centralized computing systems, they may not be as prone to catastrophic failure if one particular component ceases to function.

### SUMMARY

In accordance with the present disclosure, the disadvantages and problems associated with prior maneuvering systems may be reduced or eliminated.

In certain embodiments, an application maneuvering analysis tool accesses application characteristics information indicating one or more characteristics of an application for which a maneuver evaluation is desired. Using the accessed application characteristics information, the application maneuvering analysis tool determines a maneuverability index representing a maneuvering efficiency of the application and determines an implementation difficulty level according to the determined maneuverability index.

Certain embodiments of the present disclosure may provide one or more technical advantages. For example, certain embodiments of the application maneuvering analysis tool may provide an estimate of the amount of work to be performed to configure an application for maneuvering in a distributed computing network. The application maneuvering analysis system may leverage knowledge from users, such as those that may use the application and/or those who have authored the application, to generate information that may be useful in the evaluation and/or configuration process. The mode in which applications function may vary to a relatively large degree due to various factors, including their interaction with other computing resources or additional processes that they may generate during operation. For example, the application maneuvering analysis system may provide estimates of resources, such as monetary cost and/or labor, that may be needed for configuring applications for maneuvering in the distributed computing environment. Given this information, managers may make relatively informed decisions, such as whether to proceed with configuring certain application for maneuvers and/or allocating resources for configuring certain applications within limited budgetary constraints.

Certain embodiments of the present disclosure may provide some, all, or none of these advantages. Certain embodiments may provide one or more other technical advantages, one or more of which may be readily apparent to those skilled in the art from the figures, descriptions, and claims included herein.

### BRIEF DESCRIPTION OF THE DRAWINGS

To provide a more complete understanding of embodiments of the present disclosure and the features and advantages thereof, reference is made to the following description taken in conjunction with the accompanying drawings, in which:

FIG. 1 illustrates an example application maneuvering analysis system according to certain embodiments of the present disclosure;

FIGS. 2A through 2I illustrate an example application questionnaire that may be used to receive and/or store application characteristics information associated with an application to be configured for maneuvering by the application maneuvering analysis system of FIG. 1;

FIG. 3 illustrates an example method for receiving and processing information associated with an application to be evaluated for maneuvering; and

FIG. 4 illustrates an example method for determining an implementation difficulty level according to certain embodiments of the present disclosure.

### DESCRIPTION OF EXAMPLE EMBODIMENTS

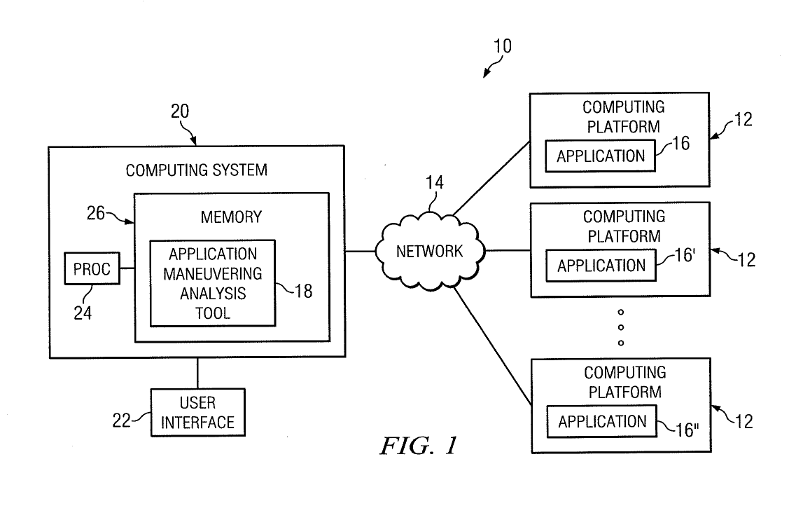

FIG. 1 illustrates an example application maneuvering analysis system 10 for analyzing maneuvers of an application in a distributed computing environment according to certain embodiments of the present disclosure. Application maneuvering analysis system 10 includes multiple computing platforms 12 communicatively coupled to a network 14. Computing platforms 12 are configured to alternatively execute an application 16, 16′, and 16″ using a maneuvering procedure such that at a given time, at least one of computing platforms 12 may be responsible for executing application 16. Application maneuvering analysis system 10 includes an application maneuvering analysis tool 18 executed on a computing system 20. As will be described in detail below, application maneuvering analysis tool 18 may access application characteristics information about application 16 and determine an implementation difficultly level for configuring the application 16 for maneuvering among computing platforms 12.

Application 16 may be any suitable type of software application, that may be maneuvered on computing platforms 12. The term ‘maneuvering’ generally refers to a process in which application 16 may be alternatively executed on one or more computing platforms 12. Computing platforms 12 that execute application 16 may include, but are not limited to, a computing system, such as a personal computer, a notebook computer, a mainframe computer, one of multiple virtual machines executed within a hypervisor, or other suitable computing systems.

A maneuvering process of application 16 generally incorporates the steps of executing application 16 on a first computing platform 12 and, after an elapsed period of time, halting execution of the application on the first computing platform 12 and initiating execution of application 16 on a second computing platform 12. In many cases, this maneuvering process may be conducted in the background such that a user of application 16 may be unaware that its movement from one computing platform 12 to another has occurred.

Maneuvering applications 16 may provide certain benefits. For example, maneuvering applications 16 may provide enhanced security against malware attacks by continually modifying the environment in which the applications 16 are executed. Cyber attackers often rely on foreknowledge of a particular environment in which applications 16 are executed in order to launch an attack. Periodic or other movement of applications 16 among multiple computing platforms 12 may reduce the ability of cyber attackers to initiate an attack by reducing or eliminating the predictability of the environment in which the applications 16 are executed.

In some cases, the process of maneuvering an application may be randomized such that alternative computing resources that execute the application may be selected at random. In this manner, further confusion may be provided to cyber attackers who may otherwise determine patterns in maneuvering procedures in which a particular application may undergo.

Some applications may require one or more configuration changes to make those applications 16 suitable for maneuvering. For example, an application may launch threads to other applications or to the operating system of the computing resource during execution of the application. As another example, an application may open files that remain generally transparent to a user, and remain open throughout execution of the application. In both cases, it may be appropriate to configure to remove the launched threads, close any open files, and reestablish the threads and files on the newly selected computing resource before and/or during the maneuvering process in order to preserve transparent operation of the applications to their users.

Configuring applications for maneuvering among multiple computing platforms 12 may involve varying levels of difficulty depending on one or more characteristics of the application. For example, certain applications may launch numerous threads with other applications while others launch relatively few or no threads during their execution. Because the complexity and/or utility provided by applications may vary, it may be useful to ascertain various characteristics of each application (e.g.) from personnel who use the application, personnel who have authored the application, and/or other suitable sources. Thus, certain embodiments may implement an application maneuvering analysis system 10 that analyzes application characteristics information for an application 16, and determines an implementation difficulty level associated with configuring the application for maneuvering.

Certain embodiments of the present disclosure may provide one or more technical advantages. For example, certain embodiments of the application maneuvering analysis tool 18 may provide an estimate of the amount of work to be performed and/or configuring an application 16 for maneuvering in a distributed computing network. Application maneuvering analysis system 10 may leverage knowledge from customers, such as those that may use application 16 and/or those who have authored application 16, to generate information that may be useful in the evaluation and/or configuration process. The mode in which applications function may vary to a relatively large degree due to various factors, including their interaction with other computing resources or additional processes that they may generate during operation. For example, application maneuvering analysis system 10 may provide estimates of resources, such as monetary cost and/or labor, that may be needed for configuring applications 16 for maneuvering in the distributed computing environment. Given this information, managers may make relatively informed decisions, such as whether to proceed with configuring certain applications 16 for maneuvers and/or allocating resources for configuring certain applications 16 within limited budgetary constraints.

Computing system 20 includes one or more processing units 24 and one or more memory units 26. A processing unit as described herein may include one or more microprocessors, controllers, or any other suitable computing devices or resources and may work, either alone or with other components of system 10, to provide a portion or all of the functionality of system 10 described herein. A memory unit as described herein may take the form of volatile and/or non-volatile memory including, without limitation, magnetic media, optical media, random access memory (RAM), read-only memory (ROM), removable media, or any other suitable memory component. A portion or all of memory units 26 may be remote from computing system 20, if appropriate.

Computing system 20 may include an application maneuvering analysis tool 18 that is operable to determine a relatively difficulty associated with configuring an application for maneuvers on distributed computing platform. Application maneuvering analysis tool 18 may be implemented in any suitable combination of hardware, firmware, and software. Additionally, application maneuvering analysis tool 18 may be implemented in a single location or in a distributed fashion (e.g., such that certain functions described with respect to application maneuvering analysis tool 18 are provided on a system other than computing system 20), according to particular needs.

Embodiments of application maneuvering analysis tool 18 may include logic contained within a medium. Logic may include hardware, software, and/or other logic. The medium in which the logic is encoded may include a tangible medium. The logic may perform operations when executed by processor units 24. Certain logic may include a computer program, software, computer executable instructions, and/or instructions capable being executed by computing system 20. The logic may also be embedded within any other suitable medium without departing from the scope of the disclosure.

Computing system 20 may include a user interface 22 for receiving input from a user, and providing output to the user. User interface 22 may include a display, such as a cathode ray tube (CRT) or a liquid crystal display (LCD) for displaying information provided by application maneuvering analysis tool 18, and one or more input devices, such as a keyboard, a mouse, a console button, or other type of user input device for inputting information to application maneuvering analysis tool 18. User interface 22 may be a part of or separate from computing system 20.

The components of application maneuvering analysis system 10, including computing platforms 12 and computing system 20 may be implemented using any suitable combination of software, firmware, and hardware. These components may be implemented using one or more computer systems at one or more locations. Each computer system may include any appropriate input devices, output devices, mass storage media, processors, memory, or other suitable components for receiving, processing, storing, and communicating data. For example, each computer system may include a personal computer, workstation, network computer, kiosk, wireless data port, personal data assistant (PDA), one or more Internet Protocol (IP) telephones, one or more servers, a server pool, one or more processors within these or other devices, or any other suitable processing device.

Each computer system of application maneuvering analysis system 10 may include one or more processing modules and one or more memory modules. A processing module may include one or more microprocessors, controllers, or any other suitable computing devices or resources. Processing modules may work, either alone or with other components of application maneuvering analysis system 10, to provide the functionality of application maneuvering analysis system 10 described herein. Each memory module may take the form of volatile or non-volatile memory including, without limitation, magnetic media, optical media, RAM, ROM, removable media, or any other suitable memory component.

Components of application maneuvering analysis system 10 may be communicatively coupled via a network 14. Network 14 facilitates wireless or wireline communication, and may communicate, for example, IP packets, Frame Relay frames, Asynchronous Transfer Mode (ATM) cells, voice, video, data, and other suitable information between network addresses. Network 14 may include one or more LANs, radio access networks (RANs), metropolitan area networks (MANs), WANs, all or a portion of the global computer network known as the Internet, and/or any other communication system or systems at one or more locations.

In operation, application maneuvering analysis tool 18 accesses application characteristics information associated with an application from a user who desires to implement the application for maneuvers. Using at least a portion of the application characteristics information, application maneuvering analysis tool 18 determines a maneuverability index representing a maneuvering efficiency of the application. In certain embodiments, the maneuverability index may be determined from numerical values assigned to elements of application characteristics information. The numerical values may be assigned with a value corresponding to their relative importance to the configuration process.

Once the maneuverability index is determined, application maneuvering analysis tool 18 may determine various metrics associated with configuring the application for maneuvers including, but not limited to, an implementation difficulty level and labor hours required to configure the application. Certain embodiments of the implementation difficulty level may include several alternative values, such as ‘easy,’ medium,’ or ‘hard’ that each corresponds to a range of values derived from values assigned to each element of the application characteristics information.

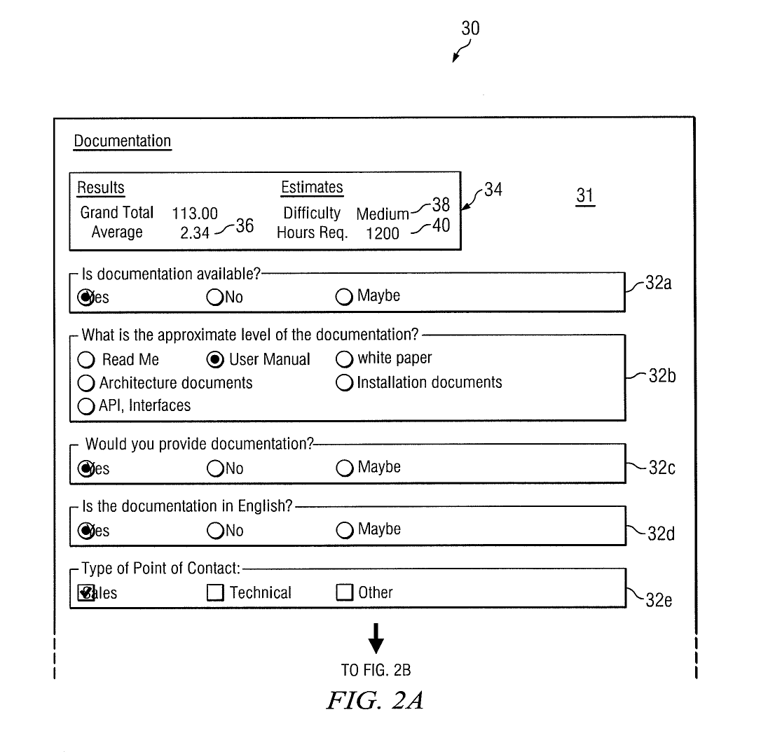

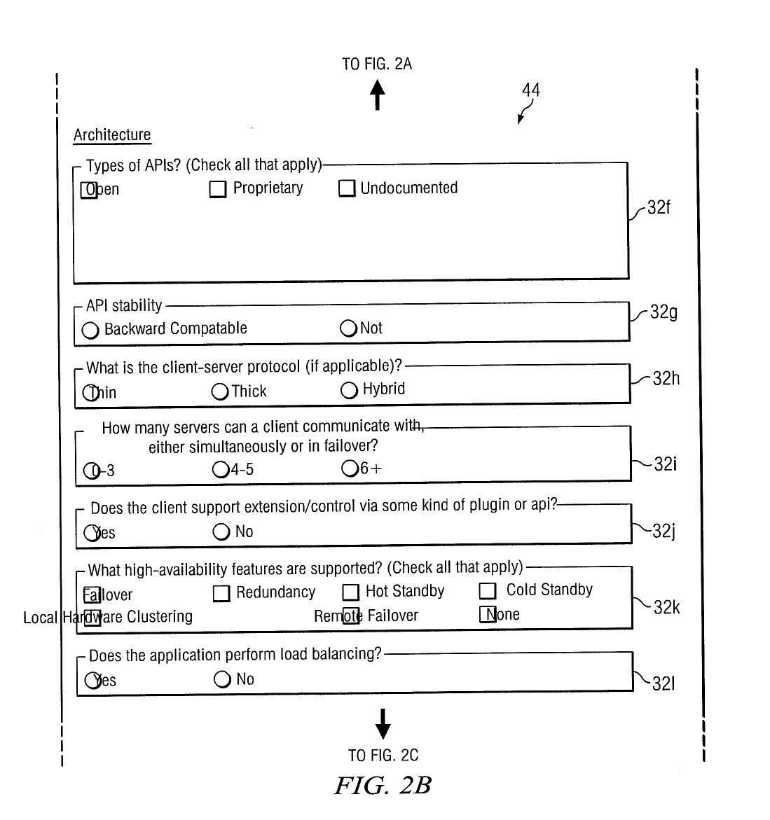

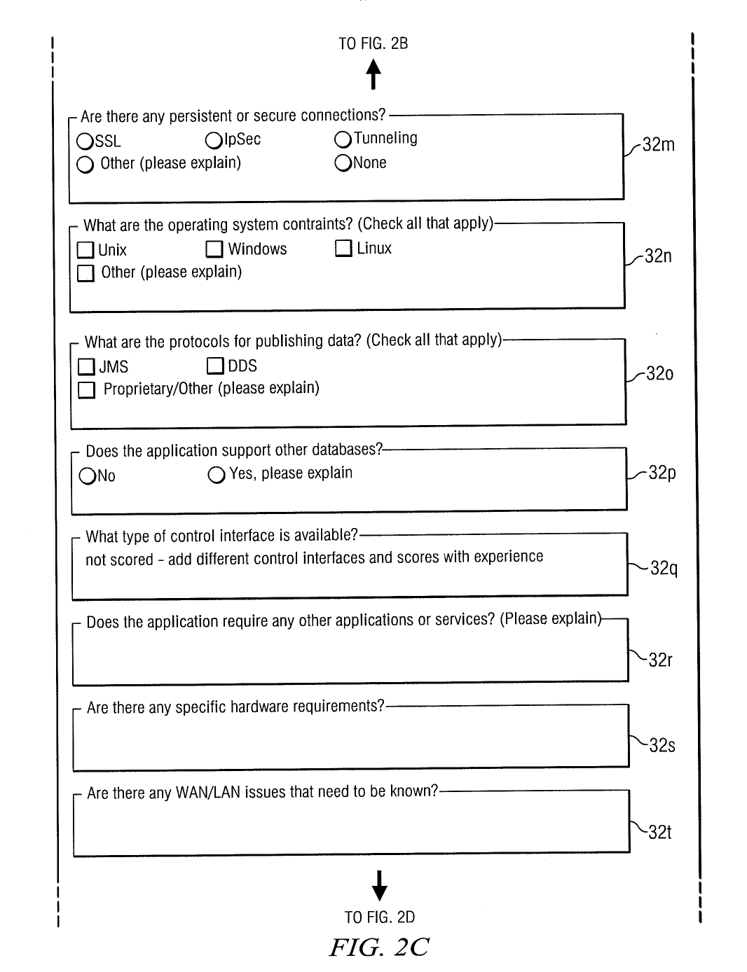

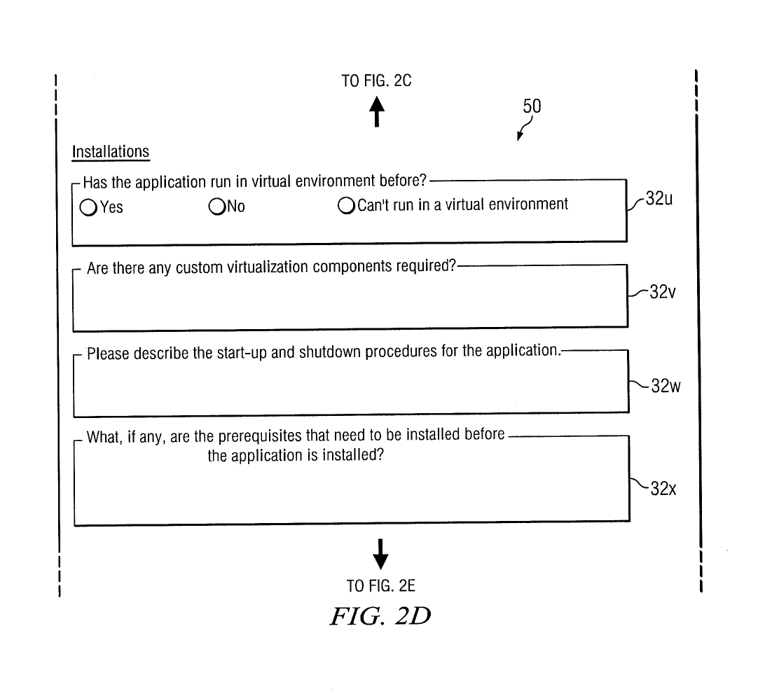

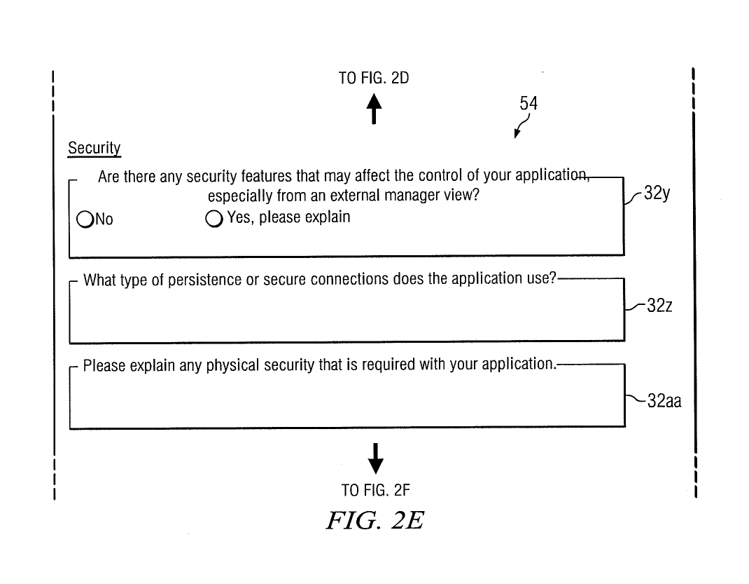

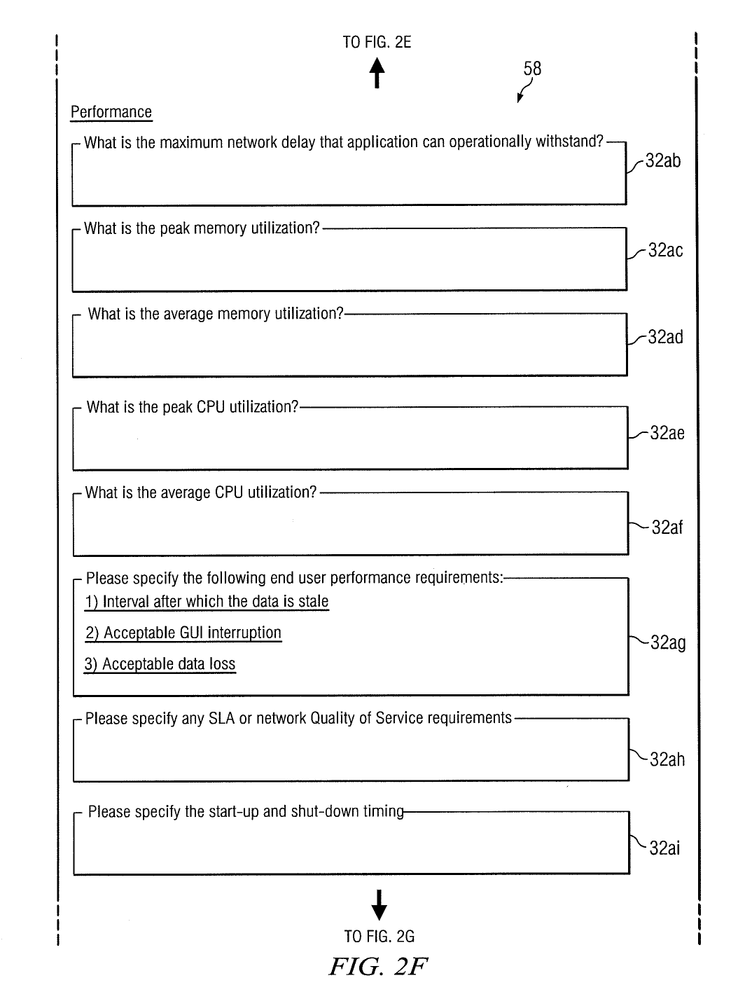

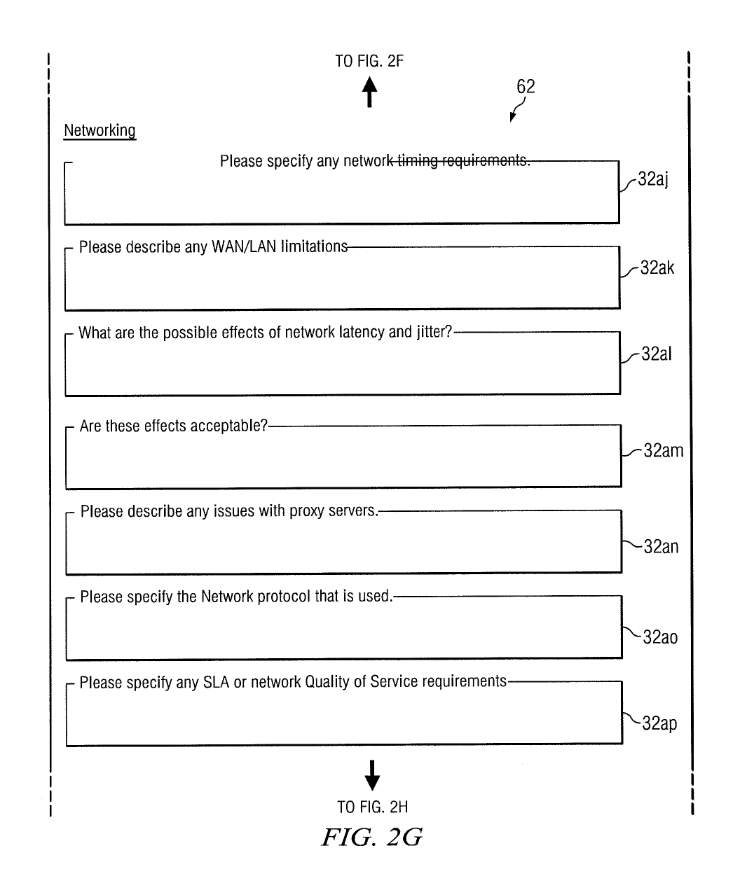

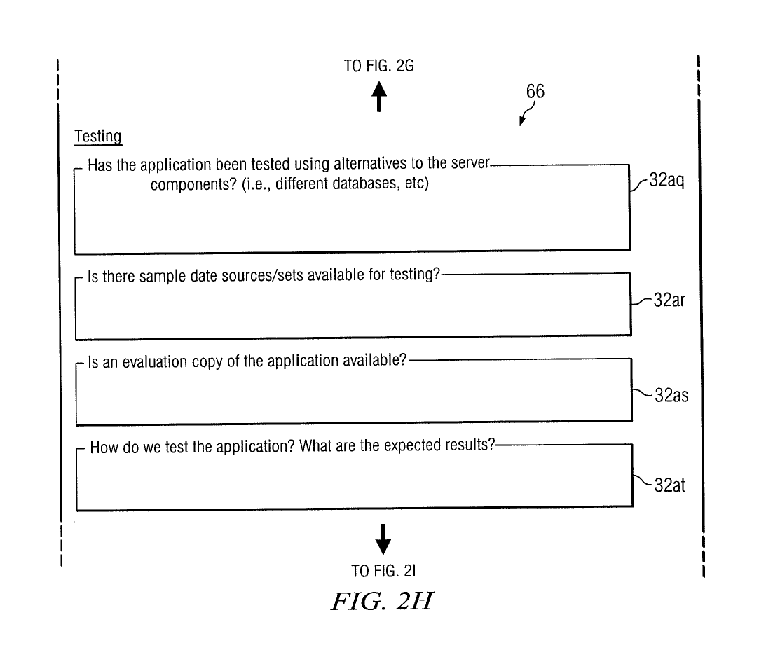

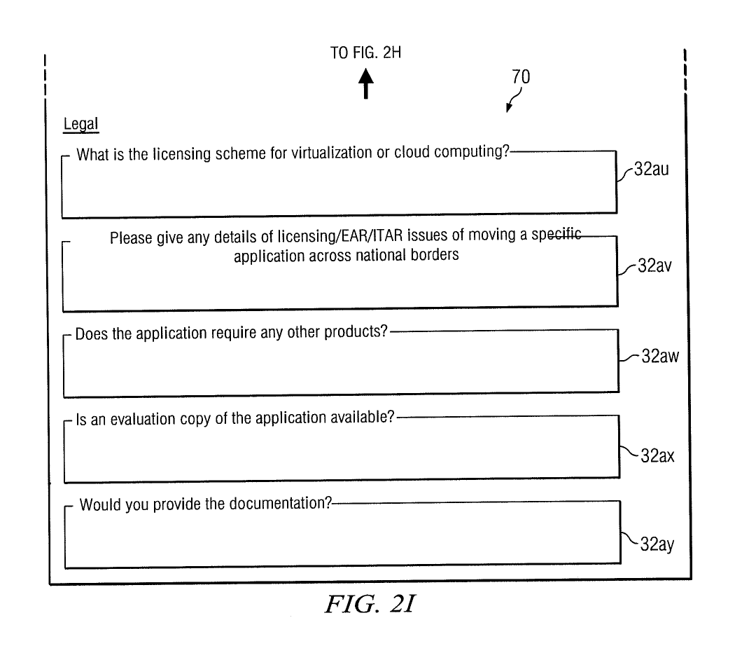

FIGS. 2A through 2I illustrate an example application questionnaire 31 that may be used to receive and/or store application characteristics information associated with an application 16 to be configured for maneuvering by the application maneuvering analysis system 10 of FIG. 1. Certain embodiments of application questionnaire 31 may include one or more windows generated on user interface 22 in which application maneuvering analysis tool 18 receives application characteristics information. Certain embodiments of application questionnaire 31 may comprise a paper document (hardcopy form) such that the application characteristics information may be entered on a paper document and transmitted using conventional techniques, such as the postal mail service, to the administrators of application maneuvering analysis system who may then input the information into computing system 20 (e.g. via user interface 22) electronically.

FIG. 2A illustrates a documentation category portion 30 of application questionnaire 31 having a number of fields 32 that may be populated with information associated with one or more documentation characteristics information associated with an application 16 to be configured for maneuvering. Application questionnaire 31 also includes a results portion 34 that displays information associated with a maneuverability index 36, an implementation difficulty level 38, and an estimated labor hours 40 required to configure the application for maneuvering.

Each field 32 may receive application characteristics information from the user in any suitable form. In the particular example shown, each field 32 includes several radio buttons that may be alternatively and/or cumulatively selected by the user. In other embodiments, fields may receive information in other forms, such as free form text, numerical values, and the like.

Information entered in fields 32 describe various characteristics that may be used to determine the implementation difficulty level for configuring the application. One example field 32a may include a documentation characteristic describing the documentation availability of the application 16. Another example field 32b may include a documentation characteristic describing the documentation level of the application 16. Another example field 32c may include a documentation characteristic describing an ability to provide the documentation associated with the application 16. Another example field 32d may include a documentation characteristic describing the language associated with the documentation. Another example field 32e may include a documentation characteristic describing ‘point of contact’ information associated with the documentation.

Certain fields 32 may each include multiple alternative and/or cumulative elements that may be selected by the user. Application maneuvering analysis tool 18 may associate particular values to that field 32 according to the selected elements. As shown, one particular field 32 displays a ‘Is documentation available?’ with three alternatively selectable elements: ‘Yes’, ‘No’, and ‘Maybe.’ Application maneuvering analysis tool 18 may assign a numerical value to this field 32 according to the element selected by the user. For example, the field 32 may be assigned with a value of ‘1’ is ‘Yes’ is selected, a value of ‘5’ is ‘No’ is selected, and a value of ‘3’ if ‘Maybe’ is selected. Application maneuvering analysis tool 18 may then use these assigned numerical values to determine maneuverability index 36.

FIGS. 2B and 2C illustrate an example architecture category portion 44 of the application questionnaire 31 of FIG. 2A. Architecture category portion 44 includes several fields 32 that receive architecture related application characteristics information associated with the application 16 to be configured. Architecture characteristics generally describe the structure of the application and how it may be executed on a host computing system.

One example field 32f may include an architecture characteristic describing one or more Application Program Interfaces (APIs) for the application. Another example field 32g may include an architecture characteristic describing the general stability of the application's API. Another example field 32h may include an architecture characteristic describing any client-server protocols, such as thin client, thick client, or some hybrid of the two. Another example field 32i may include an architecture characteristic describing how many servers that the application may simultaneously communicate with. Another example field 32j may include the ability of the application to be extended via plugins or other APIs.

Another example field 32k may include an architecture characteristic describing any associated high-availability features, such as failover, redundancy, local hardware clustering, hot standby, and/or cold standby. Another example field 32l may include an architecture characteristic may include load balancing capabilities of the application. Another example field 32m may include an architecture characteristic describing the existence of any persistent or secure connections, such as secure sockets layer (SSL) connections, an Internet Protocol Security (IpSec) connections, tunneling connections, and the like. Another example field 32n may include an architecture characteristic describing compatible operating systems, such as a Unix operating system, a Linux operating system, and/or a Windows operating system. Another example field 32o may include an architecture characteristic describing the existence of publishing protocols, such as a Java Messaging Service (JMS), or a Data Distribution Service (DDS). Another example field 32p may include an architecture characteristic describing the ability of the application to support other types of databases.

The previously described fields 32 each have several alternatively or cumulatively selectable elements to be selected by the user. Certain embodiments of application maneuvering analysis tool 18 that receives information about applications in fields 32 each having several alternatively selected elements may provide an advantage in that the implementation difficulty level and/or required labor hours may be determined with relative efficiency.

Certain embodiments may include fields 32q through 46t may be adapted to receive information in free form text that may be used to provide useful information to personnel that configure the application for maneuvering. An example field 32q that received information in free form text may include an architecture characteristic that describes the availability of any control interfaces. Another example field 32r may include an architecture characteristic describing information associated with other required applications. Another example field 32s may include an architecture characteristic describing specific hardware requirements. Another example field 32t may include an architecture characteristic describing the existence of any networking contingencies.

FIG. 2D illustrates an example installation category portion 50 of the application questionnaire 31 of FIG. 2A. Installation category portion 50 includes several fields 32 that receive installation related application characteristics information associated with the application 16 to be configured. Installation characteristics generally describe issues associated with installation of the application in a host computing environment.

One example field 32u may include an installation characteristic describing whether the application has been previously verified to be installed on a virtual machine. Another example field 32v may include an installation characteristic describing any required virtualization components. Another example field 32w may include an installation characteristic describing any startup or shutdown procedures. Another example field 32x may include an installation characteristic describing whether any prerequisite components, such as additional applications and/or operating system parameters need prior installation.

FIG. 2E illustrates an example security category portion 54 of the application questionnaire 31 of FIG. 2A. Security category portion 50 includes several fields 32 that receive security related application characteristics information associated with the application 16 to be configured.

An example field 32y may include a security characteristic describing the existence of any security features that may affect control of the application. Another example field 32z may include a security characteristic describing what type if any of persistence or secure connections that the application uses. Another example field 32aa may include a security characteristic describing any required physical security measures.

FIG. 2F illustrates an example performance category portion 58 of the application questionnaire 31 of FIG. 2A. Performance category portion 58 includes several fields 32 that receive performance related application characteristics information associated with the application 16 to be configured.

An example field 32ab may include a performance characteristic describing any network delay limitations associated with the application. Another example field 32ac may include a performance characteristic describing a peak memory utilization of the application. Another example field 32ad may include a performance characteristic describing an average memory utilization of the application. Another example field 32ae may include a performance characteristic describing a peak central processing unit (CPU) utilization of the application. Another example field 32af may include a performance characteristic describing an average central processing unit (CPU) utilization of the application. Another example field 32ag may include a performance characteristic describing the existence of any end user performance parameters, such as any intervals after which data is considered stale, acceptable Graphical User Interface (GUI) interruptions, and/or acceptable data loss parameters. Another example field 32ah may include a performance characteristic describing any specified Service Level Agreement (SLA) or Quality of Service (QoS) parameters. Another example field 32ai may include a performance characteristic describing any pertinent startup and shutdown timing parameters.

FIG. 2G illustrates an example networking category portion 62 of the application questionnaire 31 of FIG. 2A. Networking category portion 62 includes several fields 32 that receive networking related application characteristics information associated with the application 16 to be configured.

One example field 32aj may include a networking characteristic describing any network timing requirements. Another example field 32ak may include a networking characteristic describing any wide area network (WAN) or local area network (LAN) networking limitations. Another example field 32al may include a networking characteristic describing any known effects upon the application due to network latency and/or jitter, and any acceptable limits of network latency and/or jitter. Another example field 32am may include a networking characteristic describing whether the previously cited effects upon the application due to network latency and/or jitter are acceptable. Another example field 32an may include a networking characteristic describing any known issues with proxy servers. Another example field 32ao may include a networking characteristic describing any specified network protocol that may be used by the application 16. Another example field 32ap may include a networking characteristic describing any specified service level agreement (SLA) or quality of service (QoS) requirements that may be associated with the application 16.

FIG. 2H illustrates an example testing category portion 66 of the application questionnaire 31 of FIG. 2A. Testing category portion 66 includes several fields that receive testing related application characteristics information associated with the application 16 to be configured.

One example field 32aq may include a testing characteristic describing whether the application has been tested using alternatives to the server components. Another example field 32ar may include a testing characteristic describing whether any sample data sources or sample data sets are available for testing. Another example field 32as may include a testing characteristic describing whether an evaluation copy of the application is available. Another example field 32at may include a testing characteristic describing whether any test procedures and associated expected test results for the application are available.

FIG. 2I illustrates an example legal category portion 70 of the application questionnaire 31 of FIG. 2A. Legal category portion 70 includes several includes fields 32 that receive legality related application characteristics information associated with the application 16 to be configured.

One example field 32au may include a legal characteristic describing licensing schemes for operation of the application in a virtual environment and/or a cloud computing environment. Another example field 32av may include a legal characteristic describing the existence of any Export Administration Regulations (EAR) or International Traffic In Arms (ITAR) regulations associated with the application. Another example field 32aw may include a legal characteristic describing whether the application require any other product that may be bound under a licensing agreement. Another example field 32ax may include a legal characteristic describing whether an evaluation copy of the application 16 is available. Another example field 32ay may include a legal characteristic describing whether the user is willing to provide the legal documentation.

Application maneuvering analysis tool 18 may process certain fields 32 in order to determine an implementation difficulty level 38 associated with the application. Because certain fields 32 may include information that has a relatively greater relevance to the implementation difficulty level than other fields 32 each field may be associated with a weighting factor that is generally proportional to its relevance. For example, a particular type or class of applications may rely to a relatively large degree upon communication with other applications in a network. Thus, networking characteristics associated with these applications may have a higher relevance upon the implementation difficulty level than other types of applications that do not rely upon communication with other applications. By assigning a relatively high weighting factors to networking characteristics, the implementation difficulty level may determined with a relatively greater degree of precision than would otherwise be provided without the use of weighting factors assigned to each field 32.

Certain embodiments of application maneuvering analysis tool 18 may use the received characteristics to determine how the application may be maneuvered in distributed computing platform. For example, the received legal characteristics or networking characteristics may reveal information about the application that restricts their use on certain computing resources. As another example, application maneuvering analysis tool 18 may use the determined maneuverability index to determine an estimated maneuvering frequency for the application. That is, the maneuverability index may be used to determine how often the application is maneuvered from one computing resource to another.

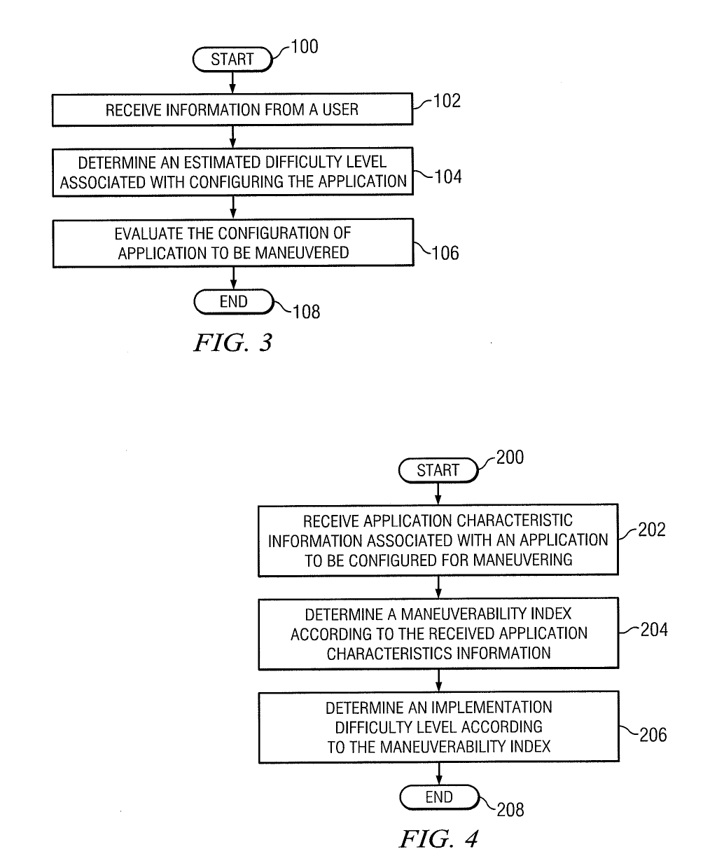

FIG. 3 illustrates an example method for receiving and processing information associated with an application to be evaluated for maneuvering. In step 100, the process is initiated.

In step 102, characteristics associated with the application are received from a user. The user may include those that may use the application 16 and/or those who have authored the application 16, to generate information that may be useful in the evaluation and/or configuration process. The characteristics may be received in hardcopy form in which the characteristics are printed on paper, or the characteristics may be received in electronic format. In certain embodiments in which characteristics are received in hardcopy form, a questionnaire file may be generated on computing system 20 via entry of characteristics through user interface 22.

In step 104, application maneuvering analysis tool 18 determines an implementation difficulty level 38 from at least some of the received characteristics. Certain fields 32 may include alternatively or cumulatively selectable fields in which the user selects one or more fields that most appropriately describes his or her application. Certain embodiments of application maneuvering analysis tool 18 may be implemented on a spreadsheet program in which fields 32 comprise the fields of the spreadsheet program. In other embodiments, the spreadsheet program may include one or more macros that are executed in the spreadsheet program's environment to determine the implementation difficulty level 38 and/or the estimated labor hours 40.

Certain embodiments of questionnaire file 16 may include fields 32 that are not used by application maneuvering analysis tool 18 to determine the maneuverability index 36, yet may provide additional information for personnel who configure the application for use on distributed computing platforms that uses maneuvering procedures. For example, questionnaire file 16 may include a field 32 for entry of information about specific hardware requirements that may not be listed in other fields 32 of questionnaire file 16. This particular field 32 may therefore, include a free form text entry portion from which the user may enter additional hardware requirements of the application. Thus, personnel who use application maneuvering analysis tool 18 may analyze information in certain fields 32 to enhance the precision of the determined implementation difficulty level 38 in certain embodiments.

In step 106, the determined implementation difficulty level 38 is used to evaluate the configuration of application 16 for maneuvers. Evaluation of application 16 may include, for example, determining whether to proceed with configuring of application 16 for maneuvering or, providing estimates of resources, such as monetary cost and/or labor, that may be needed for configuring application 16 for maneuvering in the distributed computing environment.

In certain embodiments, the implementation difficulty level 38 may be used to assign resources for configuring the application. For example, a particular application requiring a relatively large amount of labor hours may be assigned with a corresponding large number of personnel for configuring the application.

In certain embodiments, characteristics associated with application 16 may be used to generate requests (e.g., requirements or suggestions) that may be used by administrators (e.g., developers) of application 16 to improve the maneuverability index 36 of application 16. That is, some or all of the characteristics that contribute adversely to maneuverability index 36 may result in a set of requests that may be transmitted to application developers or architects of application 16. Those application developers or architects may, if they so choose, may modify application 16 and/or future applications for which maneuvering may be desired based on some or all of the characteristics that contribute adversely to maneuverability index 36. Making some or all of these modifications may improve the maneuverability index 36 of application 16 and/or the future applications.

As an example, a particular application 16 may be evaluated to determine its maneuverability index 36 and associated implementation difficulty level 38. During this evaluation, application 16 may be determined to have a ‘hard’ implementation difficulty level 38 due to lack of certain high availability features, such as load balancing and failover/redundant operation characteristics. These characteristics and their associated values contributing to the ‘hard’ implementation difficulty level 38 may be transmitted to administrators of the particular application 16 as requests to modify application 16 (or future applications) such that a future resulting implementation difficultly level 38 may be reduced to a more manageable level.

In step 108, the process ends.

FIG. 4 illustrates an example method for determining an implementation difficulty level 38 according to certain embodiments of the present disclosure. In step 200, the process is initiated.

In step 202, application maneuvering analysis tool 18 receives application characteristics information associated with one or more characteristics of an application 16 from the user. In certain embodiments, application characteristics information may be received in a application questionnaire 31 in hardcopy form or in electronic format that may be transmitted over network 14. Certain embodiments of application questionnaire 31 may be an electronic file, such as a spreadsheet file used by a spreadsheet program. In such cases, the various fields 32 may include corresponding fields of the spreadsheet program.

In step 204, application maneuvering analysis tool 18 determines a maneuverability index 36 according to at least some of the received application characteristics information. The maneuverability index 36 generally represents a maneuvering efficiency of application 16. Each element of the application characteristics information may be associated with a particular value (e.g. a numerical value) according to the answer provided by the user. In this regard, certain fields 32 may each include multiple alternative and/or cumulative elements that may be selected by the user. Application maneuvering analysis tool 18 may associate particular values to that field 32 according to the selected elements. Application maneuvering analysis tool 18 may then use these assigned numerical values to determine maneuverability index 36.

Certain embodiments of application maneuvering analysis tool 18 may assign differing weighting factors to each alternative or cumulative answer in accordance with an incremental amount of difficulty caused by the characteristic associated with the field 32. For example, one particular field 32 may include information associated with support for high availability features, such as failover, redundancy, and/or local hardware clustering. Support for the high availability features may be interpreted to mean that additional configuration steps may be required to ensure that these high availability features are handled properly when the application is halted on one computing resource and initiated on another computing resource. Thus, values assigned to each answer may be assigned such that the maneuverability index 36 reflects the maneuverability of the application to a relatively accurate degree.

In step 206, application maneuvering analysis tool determines an implementation difficulty level 38 according to the maneuverability index 36 determined in step 204. In certain embodiments, implementation difficulty level 38 may be assigned to a range of maneuverability index values. For example, those applications having a maneuverability index 36 values below a numerical value of 90 may be determined to have an ‘easy’ implementation difficulty level 38, those applications having a maneuverability index 36 values between 90 and 150 may be determined to have a ‘medium’ implementation difficulty level 38, and those applications having a maneuverability index 36 value greater than 150 may be determined to have a ‘hard’ implementation difficulty level 38. Other examples of application maneuvering analysis tool 18 may use other range values for determining implementation difficulty level 38. Additionally, the range values may be modified according to various factors, including empirical observation from previously configured applications, and the complexity of the distributed computing platform that is to perform maneuvers of the application.

The example above describes an implementation difficulty level having three values, namely ‘easy’, ‘medium’, and ‘hard.’ In other embodiments, the implementation difficulty level 38 may have less than three values, or more than three values. The values that may be assigned to the implementation difficulty level 38 may be any quantity that depicts the relative difficulty in configuring the application for maneuvers over differing computing resources.

Certain embodiments of application maneuvering analysis tool 18 may determine a labor hours 40 value according to the maneuverability index 36 determined in step 204. For example, the value of the determined maneuverability index 36 may be combined with other characteristics of the application 16, such as its storage size in memory or other factors to estimate the amount of labor hours that may be required to configure the application 16 for maneuvering.

In step 208, the process ends.

Modifications, additions, or omissions may be made to the previously described methods without departing from the scope of the disclosure. The methods may include more, fewer, or other acts. For example, the application maneuvering analysis tool 18 may use the received characteristics to determine other useful aspects of the application, such as certain licensing restrictions to be applied when the application is maneuvered to a new computing platform, or the quantity and type of users that may use the application when executed on a distributed computing platform that implements maneuvering procedures.

Although the present invention has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A system, comprising:
one or more memory units; and
one or more processing units operable to:
access application characteristics information indicating one or more characteristics of an application for which a maneuver evaluation is desired;
determine, using the accessed application characteristics information, a maneuverability index representing a maneuvering efficiency of the application; and
determine an implementation difficulty level according to the determined maneuverability index.

2. The system of claim 1, wherein the implementation difficulty level represents an estimated level of application modifications that are to be performed to prepare the application for maneuvering.

3. The system of claim 1, wherein:
the accessed application characteristics information comprises security information associated with the application; and
the one or more processors are operable to determine the maneuverability index using the security information associated with the application.

4. The system of claim 1, wherein the one or more processors are operable to:
determine, according to the determined implementation difficulty level, an estimated labor hours value associated with preparing the application for maneuvering.

5. The system of claim 1, wherein:
one or more characteristics indicated in the one or more application characteristics information are assigned a corresponding one or more weighting factors; and
the one or more processors are operable to determine the maneuverability index according to the one or more weighting factors associated with the corresponding one or more characteristics of the application.

6. The system of claim 5, wherein the one or more weighting factors are selected according to empirical observation of previously maneuvered applications.

7. The system of claim 1, wherein the one or more characteristics of the accessed application characteristics information comprise one or more of the following:
documentation availability;
architecture characteristics;
installation characteristics;
security characteristics;
performance characteristics;
networking characteristics;
testing characteristics; and
legal characteristics.

8. The system of claim 1, wherein:
the system comprises a spreadsheet program operable to execute a macro and having one or more fields that stores the one or more application characteristics information; and
the one or more processing units are operable to:
access the application characteristics information associated with the one or more characteristics that are stored in the one or more fields of the spreadsheet program; and
determine the maneuverability index using the macro executed in the spreadsheet program.

9. The system of claim 1, wherein the one or more processing units are operable to:
determine a subset of the one or more characteristics that contribute adversely to the determined implementation difficultly level; and
generate one or more requests according to the subset of characteristics, the one or more requests operable to be used by an administrator of the application to reduce a future determined implementation difficulty level of the application.

10. A method, comprising:
accessing application characteristics information indicating one or more characteristics of an application for which a maneuver evaluation is desired;
determining, using the accessed application characteristics information, a maneuverability index representing a maneuvering efficiency of the application; and
determining an implementation difficulty level according to the determined maneuverability index.

11. The method of claim 10, wherein the implementation difficulty level represents an estimated level of application modifications that are to be performed to prepare the application for maneuvering.

12. The method of claim 10, further comprising:
determining the maneuverability index using security information associated with the application, the accessed application characteristics information comprising the security information associated with the application.

13. The method of claim 10, further comprising:
determining, according to the determined implementation difficulty level, an estimated labor hours value associated with preparing the application for maneuvering.

14. The method of claim 10, further comprising:
determining the maneuverability index according to one or more weighting factors associated with the corresponding one or more characteristics of the application, the one or more characteristics indicated in the one or more application characteristics information are assigned a corresponding one or more weighting factors.

15. The method of claim 14, further comprising:
selecting the one or more weighting factors according to empirical observation of previously maneuvered applications.

16. The method of claim 10, wherein the one or more characteristics of the accessed application characteristics information comprise one or more of the following:
documentation availability;
architecture characteristics;
installation characteristics;
security characteristics;
performance characteristics;
networking characteristics;
testing characteristics; and
legal characteristics.

17. The method of claim 10, further comprising:
accessing the application characteristics information associated with the one or more characteristics that are stored in one or more fields of a spreadsheet program; and
determining the maneuverability index using a macro executed in the spreadsheet program.

18. The method of claim 10, further comprising:
determining a subset of the one or more characteristics that contribute adversely to the determined implementation difficultly level; and
generating one or more requests according to the subset of characteristics, the one or more requests operable to be used by an administrator of the application to reduce a future determined implementation difficulty level of the application.

19. Software embodied in a tangible computer-readable medium, the software when executed by one or more processing units operable to perform operations comprising:
accessing application characteristics information indicating one or more characteristics of an application for which a maneuver evaluation is desired;
determining, using the accessed application characteristics information, a maneuverability index representing a maneuvering efficiency of the application; and
determining an implementation difficulty level according to the determined maneuverability index.

20. The software of claim 19, wherein the implementation difficulty level represents an estimated level of application modifications that are to be performed to prepare the application for maneuvering.

21. The software of claim 19, further operable to:
determine the maneuverability index using security information associated with the application, the accessed application characteristics information comprising the security information associated with the application.

22. The software of claim 19, further operable to:
determine, according to the determined implementation difficulty level, an estimated labor hours value associated with preparing the application for maneuvering.

23. The software of claim 19, further operable to:
determine the maneuverability index according to one or more weighting factors associated with the corresponding one or more characteristics of the application, the one or more characteristics indicated in the one or more application characteristics information are assigned a corresponding one or more weighting factors.

24. The software of claim 23, further operable to:
select the one or more weighting factors according to empirical observation of previously maneuvered applications.

25. The software of claim 19, wherein the one or more characteristics of the accessed application characteristics information comprise one or more of the following:
documentation availability;
architecture characteristics;
installation characteristics;
security characteristics;
performance characteristics;
networking characteristics;
testing characteristics; and
legal characteristics.

26. The software of claim 19, further operable to:
access the application characteristics information associated with the one or more characteristics that are stored in one or more fields of a spreadsheet program; and
determine the maneuverability index using a macro executed in the spreadsheet program.

27. The software of claim 19, further comprising:
determine a subset of the one or more characteristics that contribute adversely to the determined implementation difficultly level; and
generate one or more requests according to the subset of characteristics, the one or more requests operable to be used by an administrator of the application to reduce a future determined implementation difficulty level of the application.
